(19) United States
(12) Patent Application Publication
(10) Pub. No.: US 2016/0110903 A1
(43) Pub. Date: Apr. 21, 2016

(54) INFORMATION PROCESSING APPARATUS, CONTROL METHOD AND PROGRAM

(71) Applicant: SQUARE ENIX HOLDINGS CO., LTD., Tokyo (JP)

(72) Inventor: Cyril PERRIN, ANTONY (FR)

(73) Assignee: SQUARE ENIX HOLDINGS CO., LTD., Tokyo (JP)

(21) Appl. No.: 14/787,029

(22) PCT Filed: May 7, 2014
(86) PCT No.: PCT/JP2014/062761

§ 371 Date: Oct. 26, 2015

Related U.S. Application Data
(60) Provisional application No. 61/820,909, filed on May 8, 2013.

(51) Int. Cl. G06T 11/60

(52) U.S. Cl. CPC G06T 11/60

(57) ABSTRACT

An information processing apparatus receives operation input for a content, and generates a first image corresponding to the content by executing a first program for the content in accordance with the received operation input. The apparatus also generates a second image to be added to the first image by executing a second program different from the first program, and outputs a composite image obtained by compositing the first image and the second image. In a case where the operation input to a region according to the second image in the composite image is received, the apparatus controls not to execute the first program in accordance with the operation input.

### TECHNICAL FIELD

The present invention relates to an information processing apparatus, a control method, and a program, and particularly to a technique of extending the function of a content by adding additional displays.

### BACKGROUND ART

Recent development of information communication technologies using networks such as the Internet has resulted in service providing to customers via the networks in various fields. Even contents that are conventionally provided as a service by executing an application in a client device such as a PC operated by a customer are handled by some of these services so that processing for execution is performed by a server on a network, and a corresponding screen is rendered and transmitted to a client device. That is, since most processes to be performed in the client device are alternatively executed on the server side, the client device needs to perform only processing of transmitting operation input done by the user to the server and processing of displaying a screen received from the server.

As one of the services of such providing form, a game screen rendered in a server is provided to a client device via a network, like so-called cloud gaming. In particular, a game content that generates fine graphics requires sufficient rendering performance of a client device. However, cloud gaming allows even a user who does not have a client device with sufficient rendering performance to play the same game as in a device having sufficient rendering performance.

In such a cloud service that renders a screen of a content on the server side and provides it, an application program and the like are preferably optimized and configured for execution on the server. However, when providing an already developed content by the cloud service, optimizing and reconfiguring the program for cloud is not realistic because of additional cost. In addition, since sources such as a program may be absent, there is a possibility that a program for content providing needs to be developed substantially from the beginning. Furthermore, if a work of, for example, reediting a program arises to add a process (function) of little relationship with the main process to an already released content, works such as debug need to be performed accordingly, and a time is required for release of the function.

### SUMMARY OF INVENTION

The present invention was made in view of such problems in the conventional technique. An aspect of the present invention provides a user experience with extended functions when providing an existing content without altering the program of the content.

The present invention in its first aspect provides an information processing apparatus comprising: receiving means for receiving operation input for a content; first generation means for generating a first image corresponding to the content by executing a first program for the content in accordance with the operation input received by the receiving means; second generation means for generating a second image to be added to the first image by executing a second program different from the first program; output means for outputting a composite image obtained by compositing the first image and the second image; and control means for, in a case where the receiving means receives the operation input to a region according to the second image in the composite image, controlling not to cause the first generation means to execute the first program in accordance with the operation input.

The present invention in its second aspect provides an information processing apparatus comprising: receiving means for receiving operation input for a content; first generation means for generating a first image corresponding to the content by executing a first program for the content in accordance with the operation input received by the receiving means; monitor means for monitoring a predetermined parameter that changes during execution of the first program; second generation means for generating a second image to be added to the first image by executing a second program different from the first program in a case where the predetermined parameter meets a predetermined condition; and output means for outputting a composite image obtained by compositing the first image and the second image.

The present invention in its third aspect provides an information processing apparatus comprising: receiving means for receiving operation input for a content; first, generation means for generating a first image corresponding to the content by executing a first program for the content in accordance with the operation input received by the receiving means; analysis means for analyzing the first image and detecting whether an execution state of the content meets a predetermined condition; second generation means for generating a second image to be added to the first image by executing a second program different from the first program in a case where the execution state meets the predetermined condition; and output means for outputting a composite image obtained by compositing the first image and the second image.

The present invention in its fourth aspect provides an information processing apparatus comprising receiving means for receiving operation input for a content; first generation means for generating a first image corresponding to the content by executing a first program for the content in accordance with the operation input received by the receiving means; analysis means for analyzing the first image and deciding a position where a display item is to be arranged; second generation means for generating a second image to be added to the first image, in which the display item is arranged at the position decided by the analysis means, by executing a second program different from the first program; and output means for outputting a composite image obtained by compositing the first image and the second image.

Further features of the present invention will become apparent from the following description of exemplary embodiments (with reference to the attached drawings).

### BRIEF DESCRIPTION OF DRAWINGS

FIG. 1 is a block diagram of a cloud-based video game system architecture, according to a non-limiting embodiment of the present invention.

FIG. 2A is a block diagram showing various physical components of the architecture of FIG. 1, according to a non-limiting embodiment of the present invention.

FIG. 2B is a variant of FIG. 2A.

FIG. 2C is a block diagram showing various functional modules of the architecture of FIG. 1, which can be implemented by the physical components of FIGS. 2A or 2B.

FIGS. 3A to 3C are flowcharts showing execution of a set of processes carried out during execution of a video game, in accordance with non-limiting embodiments of the present invention.

FIGS. 4A and 4B are flowcharts showing operation of a client device to process received video and audio, respectively, in accordance with non-limiting embodiments of the present invention.

FIGS. 5A and 5B are block diagram showing a functional arrangement on a server side according to an embodiment or a modification of the present invention.

FIG. 6 is a flowchart, exemplary showing menu extension processing performed on the server side according to the embodiment of the present invention.

FIGS. 7A, 7B and 7C are views exemplary showing the structures of images before and after composite processing in the menu extension processing according to the embodiment of the present invention.

FIGS. 8A and 8B are flowcharts exemplary showing display update processing performed on the server side according to the embodiment of the present invention.

FIGS. 9A and 9E are views exemplary showing the structures of superimposed images generated by the display update processing.

FIGS. 10A, 10B and 10C are views exemplary showing the structures of images before and after composite processing according to a modification of the present invention.

FIGS. 11A and 11E are views showing the structures of composite images according to the third modification of the present invention.

### DESCRIPTION OF EMBODIMENTS

I. Cloud Gaming Architecture

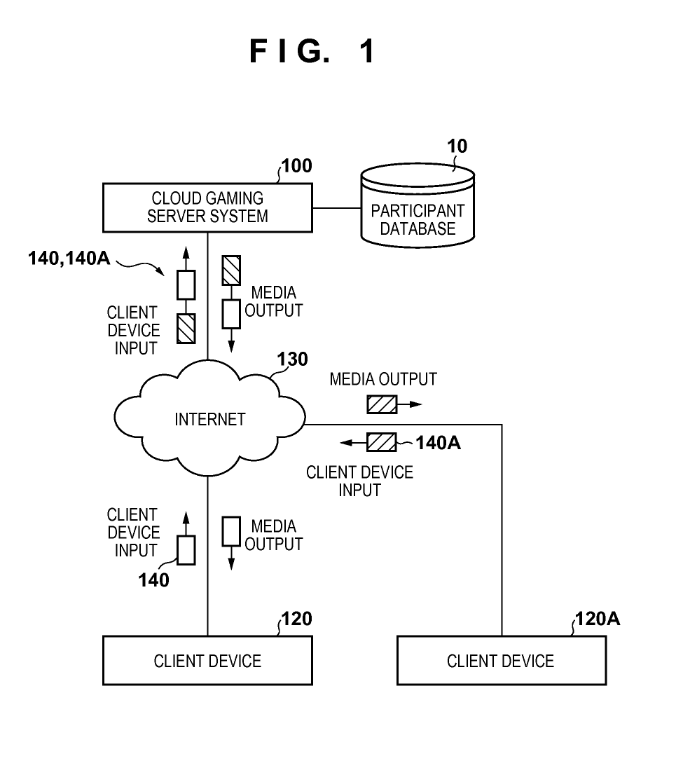

FIG. 1 schematically shows a cloud-based video game system architecture according to a non-limiting embodiment of the present invention. The architecture includes client devices 120, 120A connected to a cloud gaming server system 100 over a data network such as the Internet 130. Each of the client devices 120, 120A may connect to the Internet 130 in any suitable manner, including over a respective local access network (not shown). The cloud gaming server system 100 may also connect to the Internet 130 over a local access network (not shown), although the server system 100 may connect directly to the Internet 130 without the intermediary of a local access network. Connections between the cloud gaming server system 100 and one or more of the client devices 120, 120A may comprise one or more channels. These channels can be made up of physical and/or logical links, and may travel over a variety of physical media, including radio frequency, fiber optic, free-space optical, coaxial and twisted pair. The channels may abide by a protocol such as UDP or TCP/IP. Also, one or more of the channels may be supported a virtual private network (VPN). In some embodiments, one or more of the connections may be session-based.

The cloud gaming server system 100 enables users of the client devices 120, 120A to play video games, either individually (i.e., a single-player video game) or in groups (i.e., a multiplayer video game). Non-limiting examples of video games may include games that are played for leisure, education and/or sport. A video game may but need not offer participants the possibility of monetary gain. Although only two client devices 120, 120A are shown, it should be appreciated that the number oil client devices in the cloud-based video game system architecture is not particularly limited.

A user of one of the client devices 120, 120A may register with the cloud gaming server system 100 as a participant in a video game. The user may register as a “player”, and will have the opportunity to control character, avatar, race car, cockpit, etc, within a virtual world maintained by the video game. In the case of a multi-player video game, the virtual world is shared by two or more players, and one player's gameplay may affect that of another. In some embodiments, a user of one of the client devices 120, 120A may register as a non-player “spectator”, whereby such users will observe players' gameplay but otherwise do not control active characters in the game. Unless otherwise indicated, where the term “participant” is used, it is meant to apply equally to players and spectators.

The server system 100 may include one or more computing resources, including one or more game servers and one or more account servers. The game servers and the account servers may be embodied in the same hardware or they may be different servers that are connected via a communication link, including possibly over the Internet 130. In the following description, they are treated as separate servers merely in the interest of simplicity.

A game server interacts with players in the course of a game, while an account server interacts with players outside the game environment. Thus, for example, the account server may be configured for logging a prospective player into a game portal, tracking the player's connectivity over the Internet, and responding to the player's commands to launch, join, exit; or terminate an instance of a game, among several non-limiting functions. To this end, the account server may host or have access to a participant database 10 that stores account information about various participants and client devices 120, 120A, such as identification data, financial data, location data, demographic data, connection data and the like. The participant database 10 which can he part of the cloud gaming server system 100 or situated remotely therefrom. The game server 110 may also have access to the participant database 10 that stores the above mentioned account information, as this information may be used for influencing the way in which the video game progresses.

The configuration of any given one of the client devices 120, 120A is not particularly limited. In some embodiments, one or more of the client devices 120, 120A may be, for example, a personal computer (PC), a home game machine (console such as XBOX™, PS3™, Wii™, etc.), a portable game machine, a smart television, a set-top box (STB), etc. In other embodiments, one or more of the client, devices 120, 120A may be a communication or computing device such as a mobile phone, a personal digital assistant (PDA), or a tablet.

Any given one of the client devices 120, 120A may be equipped with one or more input devices (such as a touch screen, a keyboard, a game controller, a joystick, etc.) to allow users of the given client device to provide input and participate in a video game. In other embodiments, the user may produce body motion or may wave an external object; these movements are detected by a camera or other sensor (e.g., Kinect™), while software operating within the given client device attempts to correctly guess whether the user intended to provide input to the given client device and, if so, the nature of such input. The given client device translates the received user inputs and detected user movements into “client device input”, which is sent to the cloud gaming server system 100 over the Internet 130, in the illustrated embodiment, client, device 120 produces client device input 140, while, client device 120A produces client device input 140A.

The cloud gaming server system 100 processes the client device input 140, 140A received from the various client devices 120, 120A and generates “media output” for the various client devices 120, 120A. The media output may include a stream of encoded video data (representing images when displayed on a screen) and audio data (representing sound when played via a loudspeaker). The media output is sent over the Internet 130 in the form of packets. Packets destined for a particular one of the client devices 120, 120A may be addressed in such a way as to be routed to that device over the Internet 130. Each of the client devices 120, 120A may include circuitry for buffering and processing the media output in the packets received from the cloud gaming server system 100, as well as a display for displaying images and a transducer (e.g., a loudspeaker) for outputting audio. Additional output devices may also be provided, such as an electro-mechanical system to induce motion.

It should be appreciated that a stream of video data can be divided into “frames”. The term “frame” as used herein does not require the existence of a one-to-one correspondence between frames of video data and images represented by the video data. That is to say, while it is possible for a frame of video data to contain data representing a respective displayed image in its entirety, it is also possible for a frame of video data to contain data representing only part of an image, and for the image to in fact require two or more frames in order to be properly reconstructed and displayed. By the same token, a frame of video data may contain data representing more than one complete image, such that N images may be represented using M frames of video data, where M<N.

II. Cloud Gaming Server System 100 (Distributed Architecture)

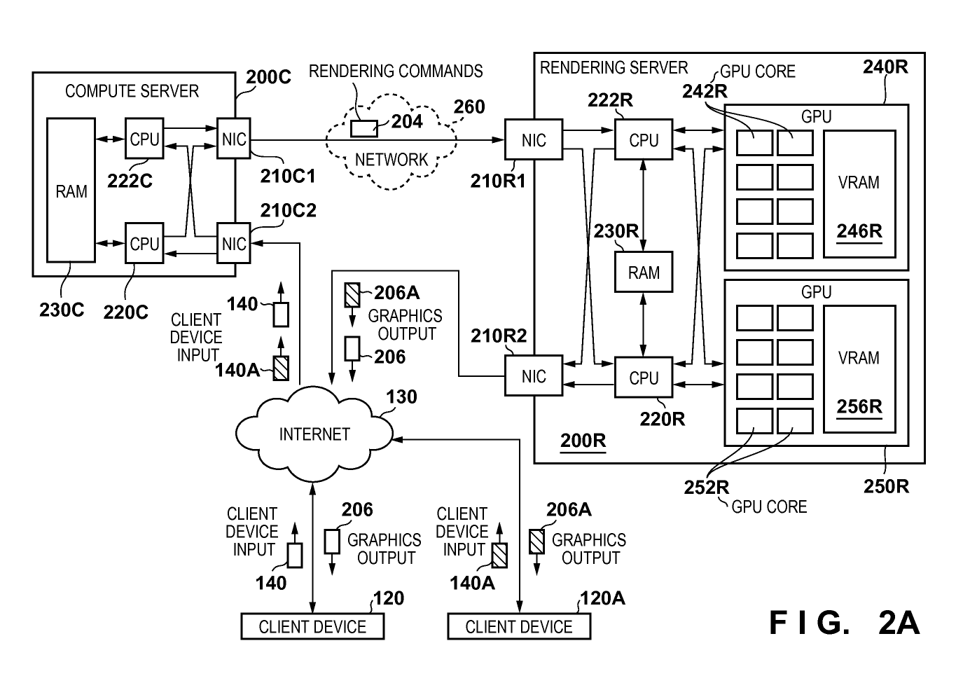

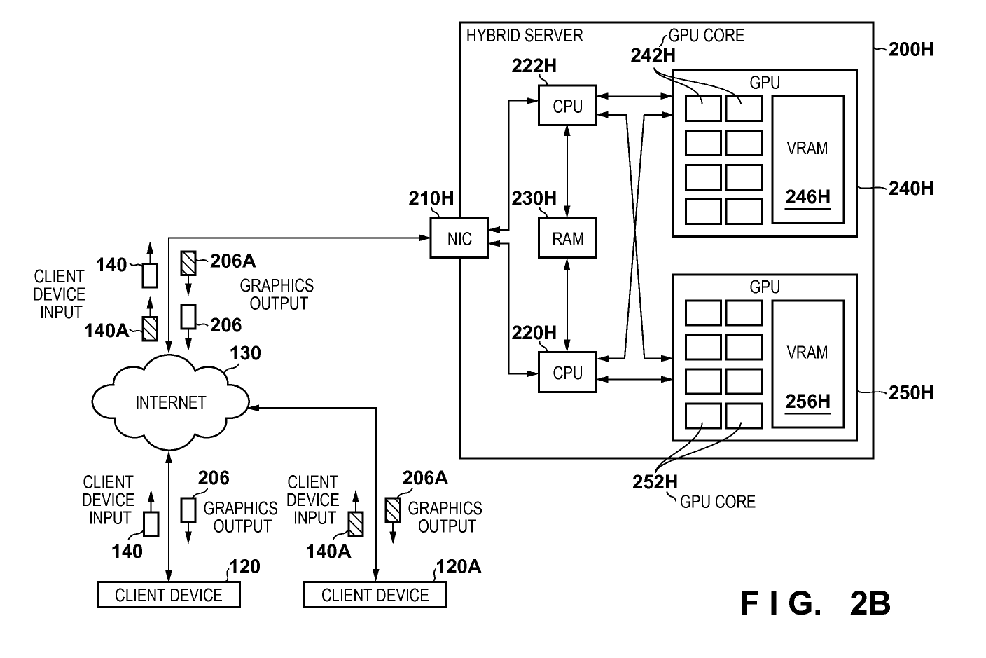

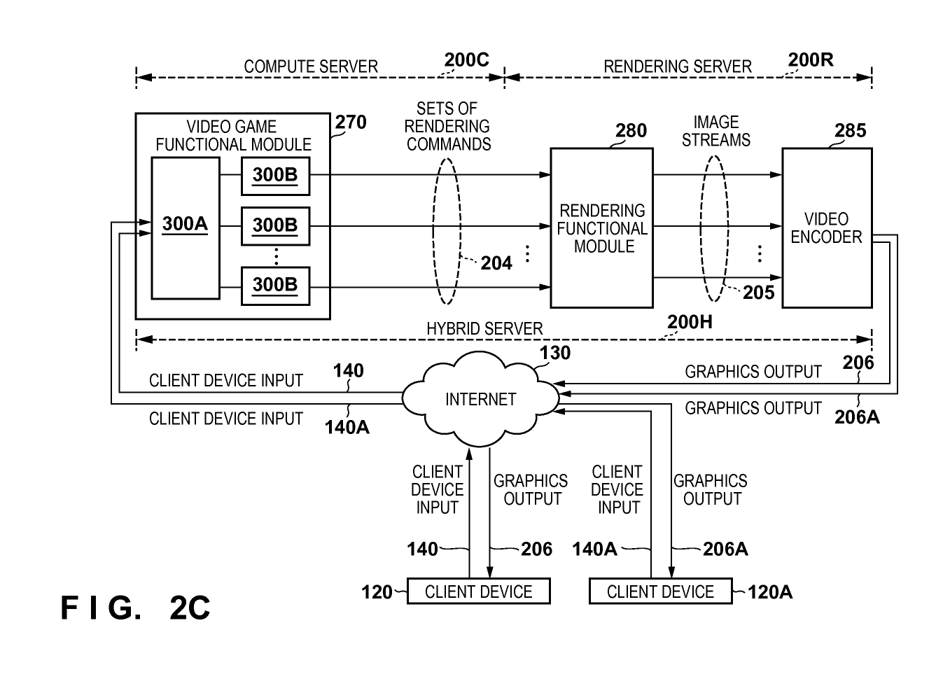

FIG. 2A shows one possible non-limiting physical arrangement of components for the cloud gaming server system 100. In this embodiment, individual servers within the cloud gaming server system 100 are configured to carry out specialized functions. For example, a compute server 200C may be primarily responsible for tracking state changes in a video game based on user input, while a rendering server 200R may be primarily responsible for rendering graphics (video data).

For the purposes of the presently described example embodiment, both client device 120 and client device 120A are assumed to be participating in the video game, either as players or spectators. However, it should be understood that in some cases there may be a single player and no spectator, while in other cases there may be multiple players and a single spectator, in still other cases there may be a single player and multiple spectators and in yet other cases there may be multiple players and multiple spectators.

For the sake of simplicity, the following description refers to a single compute server 200C connected to a single rendering server 200R. However, it should be appreciated that there may be more than one rendering server 200R connected to the same compute server 200C, or more than one compute server 200C connected to the same rendering server 200R. In the case where there are multiple rendering servers 200R, these may be distributed over any suitable geographic area.

As shown in the non-limiting physical arrangement of components in FIG. 2A, the compute server 200C comprises one or more central processing units (CPUs) 220C, 222C and a random access memory (RAM) 230. The CPUs 220C, 222C can have access to the RAM 230C over a communication bus architecture, for example. While only two CPUs 220C, 222C are shown, it should be appreciated that a greater number of CPUs, or only a single CPU, may be provided. In some example implementations of the compute server 200C. The compute server 200C also comprises a network interface component (NIC) 210C2, where client device input is received over the Internet 130 from each of the client devices participating in the video game. In the presently described example embodiment, both client device 120 and client device 120A are assumed to be participating in the video game, and therefore the received client device input may include client device input 140 and client device input 140A.

The compute server 200C further comprises another network interface component (NIC) 210C1, which outputs a sets of rendering commands 204. The sets of rendering commands 204 output from the compute server 200C via the NIC 210C1 can be sent to the rendering server 200R. In one embodiment, the compute server 200C can be connected directly to the rendering server 200R. In another embodiment, the compute server 200C can be connected to the rendering server 200R over a network 260, which can be the Internet 130 or another network. A virtual private network (VPN) may be established between the compute server 200C and the rendering server 200R over the network 260.

At the rendering server 200R, the sets of rendering commands 204 sent by the compute server 200C are received at a network interface component (NIC) 210R1 and are directed to one or more CPUs 220R, 222R. The CPUs 220R, 222R are connected to graphics processing units (GPUs) 240R, 250R. By way of non-limiting example, GPU 240R may include a set of GPU cores 242R and a video random access memory (VRAM) 246R. Similarly, GPU 250R may include a set of GPU cores 252R and a video random access memory (VRAM) 256R, Each of the CPUs 220R, 222R may be connected to each of the GPUs 240R, 250R or to a subset of the GPUs 240R, 250R, Communication between the CPUs 220R, 222R and the GPUs 240R, 250R can be established using, for example, a communications bus architecture. Although only two CPUs and two GPUs are shown, there may be more than two CPUs and GPUs, or even just a single CPU or GPU, in a specific example of implementation of the rendering server 200R.

The CPUs 220R, 222R cooperate with the GPUs 240R, 250R to convert the sets of rendering commands 204 into a graphics output streams, one for each of the participating client devices. In the present embodiment, there are two graphics output streams 206, 206A for the client devices 120, 120A, respectively. This will be described in further detail later on The rendering server 200R comprises a further network interface component (NIC) 210R2, through which the graphics output streams 206, 206A are sent to the client devices 120, 120A, respectively.

III. Cloud Gaming Server System 100 (Hybrid Architecture)

FIG. 2B shows a second possible non-limiting physical arrangement of components for the cloud gaming server system 100. In this embodiment, a hybrid server 200H is responsible both for tracking state changes in a video game based on user input, and for rendering graphics (video data).

As shown in toe non-limiting physical arrangement of components in FIG. 2B, the hybrid server 200H comprises one or more central processing units (CPUs) 220H, 222H and a random access memory (RAM) 230H. The CPUs 220H, 222H can have access to the RAM 230H over a communication bus architecture, for example. While only two CPUs 220H, 222H are shown, it should be appreciated that a greater number of CPUs, or only a single CPU, may be provided in some example implementations of the hybrid server 200H. The hybrid server 200H also comprises a network interface component (NIC) 210H, where client device input is received over the Internet 130 from each of the client devices participating in the video game. In the presently described example embodiment, both client device 120 and client device 120A are assumed to be participating in the video game, and therefore the received client device input may include client device input 140 and client device input 140A.

In addition, the CPUs 220H, 222H are connected to a graphics processing units (GPUs) 240H, 250H. By way of non-limiting example, GPU 240E may include a set of GPU cores 242H and a video random access memory (VRAM) 246H. Similarly, GPU 250H may include a set of GPU cores 252H and a video random access memory (VRAM) 256H. Face of the CPUs 220H, 222H may be connected to each of the GPUs 240H, 250H or to a subset of the GPUs 240H, 250H. Communication between the CPUs 220H, 222H and the GPUs 240H, 250H can be established using, for example, a communications bus architecture. Although only two CPUs and two GPUs are shown, there may be more than two CPUs and GPUs, or even just a single CPU or GPU, in a specific example of implementation of the hybrid server 200H.

The CPUs 220H, 222H cooperate with the GPUs 240H, 250H to convert the sets of rendering commands 204 into graphics output streams, one for each of the participating client devices. In this embodiment, there are two graphics output streams 206, 206A for the participating client devices 120, 120A, respectively. The graphics output streams 206, 206A are sent to the client devices 120, 120A, respectively, via the NIC 210H.

IV. Cloud Gaming Server System 100 (Functionality Overview)

With additional reference now to FIG. 2C, the above-described physical components of the compute server 200C and the rendering server 200R (in FIG. 2A) and/or of the hybrid server 200H (in FIG. 2B) implement a set of functional modules, including a video game functional module 270, a rendering functional module 280 and a video encoder 285. According to the non-limiting embodiment of FIG. 2A, the video game functional, module 270 is implemented by the compute server 200C, while the rendering functional module 280 and the video encoder 285 are implemented by the rendering server 200R. According to the non-limiting embodiment of FIG. 2B, the hybrid server 200H implements the video game functional module 270, the rendering functional module 280 and the video encoder 285.

The present example embodiment discusses a single video game functional module 270 for simplicity of illustration. However, it should be noted that in an actual implementation of the cloud gaming server system 100, many video game functional modules similar to the video game functional module 270 would be executed in parallel. Thus, the cloud gaming server system 100 could support multiple independent instantiations of the same video game, or multiple different video games, simultaneously. Also, it should be noted that the video games can be single-player video games or multi-player games of any type.

The video game functional module 270 may be implemented by certain physical components of the compute server 200C (in FIG. 2A) or of the hybrid server 200H (in FIG. 2B). Specifically, the video game functional module 270 can be encoded as computer-readable instructions that are executable by a CPU (such as the CPUs 220C, 222C in the compute server 200C or the CPUs 220H, 222H in the hybrid server 200H). The instructions can be tangibly stored in the RAM 230C (in the compute server 200C) of the RAM 230H (in the hybrid server 200H) or in another memory area, together with constants, variables and/or other data used the video came functional module 270. In some embodiments, the video game functional module 270 may be executed within the environment of a virtual machine that may be supported by an operating system that is also being executed by a CPU (such as the CPUs 220C, 222C in the compute server 200C or the CPUs 220H, 222H in the hybrid server 200H).

The rendering functional module 200 may implemented by certain physical components of the rendering server 200R (in FIG. 2A) or of the hybrid server 200H (in FIG. 2B). In an embodiment, the rendering functional module 280 may take up one or more GPUs (240R, 250R in FIG. 2A, 240H, 250H in FIG. 2B) and may or may not utilize CPU resources.

The video encoder 285 may be implemented by certain physical components of the rendering server 200R (in FIG. 2A) or of the hybrid server 200H (in FIG. 2B). Those skilled in the art will appreciate that there are various ways in which to implement the video encoder 285. In the embodiment of FIG. 2A, the video encoder 285 may be implemented by the CPUs 220R, 222R and/or by the GPUs 240R, 250R. In the embodiment of FIG. 2B, the video encoder 285 may be implemented by the CPUs 220H, 222H and/or by the GPUs 240E, 250H. In yet another embodiment, the video encoder 285 may be implemented by a separate encoder chip (not shown).

In operation, the video game functional module 270 produces the sets of rendering commands 204, based on received client device input. The received client device input may carry data (e.g., an address) identifying the video game functional module for which it is destined, as well as data identifying the user and/or client device from which it originates. Since the users of the client devices 120, 120A are participants in the video game (i.e., players or spectators), the received client device input includes the client device input 140, 140A received from the client devices 120, 120A.

Rendering commands refer to commands which can be used to instruct a specialized graphics processing unit (GPU) to produce a frame of video data or a sequence of frames of video data. Referring to FIG. 2C, the sets of rendering commands 204 result in the production of frames of video data by the rendering functional module 280. The images represented by these frames change as a function of responses to the client device input 140, 140A that are programmed into the video game functional module 270. For example, the video game functional module 270 may be programmed in such a way as to respond to certain specific stimuli to provide the user with an experience of progression (with future interaction being made different, more challenging or more exciting), while the response to certain other specific stimuli will provide the user with an experience of regression or termination. Although the instructions for the video game functional module 270 may be fixed in the form of a binary executable file, the client device input 140, 140A is unknown until the moment of interaction with a player who uses the corresponding client device 120, 120A. As a result, there can be a wide variety of possible outcomes, depending on the specific client device input that is provided. This interaction between players/spectators and the video came functional module 270 via the client devices 120, 120A can be referred to as “gameplay” or “playing a video game”.

The rendering functional module 280 processes the sets of rendering commands 204 to create multiple video data streams 205. Generally, there will be one video data stream per participant (or, equivalently, per client device). When performing rendering, data for one or more objects represented in three-dimensional space (e.g., physical objects) or two-dimensional space (e.g., text) may be loaded into a cache memory (not shown) of a particular GPU 240R, 250R, 240H, 250H. This data may be transformed by the GPU 240R, 250R, 240H, 250H into data representative of a two-dimensional image, which may be stored in the appropriate VRAM 246R, 256R, 246H, 256H. As such, the VRAM 246R, 256R, 246H, 256H may provide temporary storage of picture element (pixel) values for a game screen.

The video encoder 285 compresses and encodes the video data in each of the video data streams 205 into a corresponding stream of compressed/encoded video data. The resultant streams of compressed/encoded video data, referred to as graphics output streams, are produced on a per-client-device basis. In the present example embodiment, the video encoder 285 produces graphics output stream 206 for client device 120 and graphics output stream 206A for client device 120A. Additional functional modules may be provided for formatting the video data into packets so that they can be transmitted over the Internet 130. The video data in the video data streams 205 and the compressed/encoded video data within a given graphics output stream may be divided into frames.

V. Generation of Rendering Commands

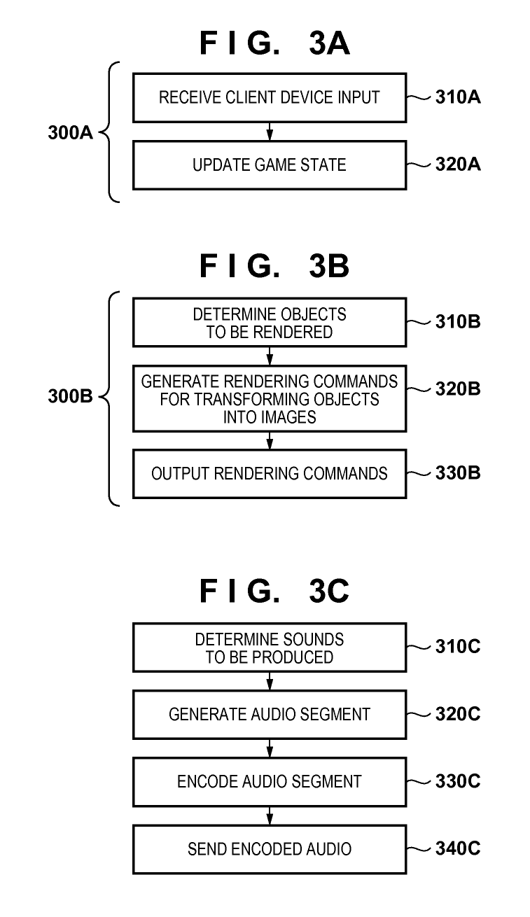

Generation of rendering commands by the video game functional module 270 is now described in greater detail with reference to FIGS. 2C, 3A and 3B. Specifically, execution of the video game functional module 270 involves several processes, including a main game process 300A and one or more graphics control processes 300B, which are described herein below in greater detail.

Main Game Process

A first process, referred to as the main game process, is described with reference to FIG. 3A. The main game process 300A executes continually. As part of the main game process 300A, there is provided an action 310A, during which client device input may be received. If the video game is a single-player video game without the possibility of spectating, then client device input (e.g., client device input 140) from a single client device (e.g., client device 120) is received as part of action 310A. If the video game is a multi-player video game or is a single-player video game with the possibility of spectating, then the client device input (e.g., the client device input 140 and 140A) from one or more client devices (e.g., the client devices 120 and 120A) may be received as part of action 310A.

By way of non-limiting example, the input from a given client device may convey that the user of the given client device wishes to cause a character under his or her control to move, jump, kick, turn, swing, pull, grab, etc. Alternatively or in addition, the input from the given client device may convey a menu selection made by the user of the given client device in order to change one or more audio, video or gameplay settings, to load/save a game or to create or join a network session. Alternatively or in addition, the input from the given client device may convey that the user of the given client device wishes to select a particular camera view (e.g., first-person or third-person) or reposition his or her viewpoint within the virtual world.

At action 320A, the game state may be updated based at least in part on the client device input received at action 310A and other parameters. Updating the game state may involve the following actions:

Firstly, updating the game state may involve updating certain properties of the participants (player or spectator) associated with the client devices from which the client device input may have been received. These properties may be stored in the participant database 10. Examples of participant properties that may be maintained in the participant database 10 and updated at action 320A can include a camera view selection (e.g., 1st person, 3rd person), a mode of play, a selected audio or video setting, a skill level, a customer grade (e.g., guest, premium, etc.).

Secondly, updating the game state may involve updating the attributes of certain objects in the virtual world based on an interpretation of the client device input. The objects whose attributes are to be updated may in some cases be represented by two- or three-dimensional models and may include playing characters, non-playing characters and other objects. In the case of a playing character, attributes that can be updated may include the object's position, strength, weapons/armor, lifetime left, special powers, speed/direction (velocity), animation, visual effects, energy, ammunition, etc. In the case of other objects (such as background, vegetation, buildings, vehicles, score board, etc.), attributes that can be updated may include the object's position, velocity, animation, damage/health, visual effects, textual content, etc.

It should be appreciated that parameters other than client device input can influence the above properties (of participants) and attributes (of virtual world objects). For example, various timers (such as elapsed time, time since a particular event, virtual time of day, total number of players, a participant's geographic location, etc.) can have an effect on various aspects of the game state.

Once the game state has been updated further to execution of action 320A, the main game process 300A returns to action 310A, whereupon new client device input received since the last pass through the main game process is gathered and processed.

Graphics Control Process

A second process, referred to as the graphics control process, now described with reference to FIG. 3B. The graphics control process 300B may execute continually, and there may be multiple separate graphics control processes 300B, each of which results in a respective one of the sets of rendering commands 204. In the case of a single-player video game without the possibility of spectating, there is only one player and therefore only one resulting set of rendering commands 204, and thus the graphics control process 300B may execute as an extension of the main game process 300A described above. In the case of a multi-player video game, multiple distinct sets of rendering commands need to be generated for the multiple players, and therefore multiple graphics control processes 300B may execute in parallel. In the case of a single-player game with the possibility of spectating, there may again be only a single set of rendering commands 204, and therefore a single graphics control process 300B may execute in the video game functional module 270, but the resulting video data stream may be duplicated for the spectators by the rendering functional module 280. Of course, these are only examples of implementation and are not to be taken as limiting.

At action 310B of the graphics control process 300B for a given participant requiring a distinct video data stream, the video game functional module 270 determines the objects to be rendered for the given participant. This action can include identifying the following types of objects:

Firstly, this action can include identifying those objects from the virtual world that are in the “game screen rendering range” (also known as a “scene”) for the given participant. The game screen rendering range includes the portion of the virtual world that would be “visible” from the perspective of the given participant's camera. This depends on The position and orientation of that camera relative to the objects in the virtual world. In a non-limiting example of implementation of action 310B, a frustum can be applied to the virtual world, and the objects within that frustum are retained or marked. The frustum has an apex which is situated at the location of the given participant's camera and has a directionality also defined by the directionality of that camera.

Secondly, this action can include identifying additional objects that do not appear in the virtual world, but which nevertheless are to be rendered for the given participant. For example, these additional objects may include textual messages, graphical warnings and dashboard indicators, to name a few non-limiting possibilities.

At action 320B, the video game functional module 270 generates a set of commands for transforming rendering into graphics (video data) the objects that were identified at action 310B. Rendering may refer to the transformation of 3-D or 2-D coordinates of an object or group of objects into data representative of a displayable image, in accordance with the viewing perspective and prevailing lighting conditions. This can be achieved using any number of different algorithms and techniques, for example as described in “Computer Graphics and Geometric Modelling: Implementation & Algorithms”, Max K. Agoston, Springer-Verlag London Limited, 2005, hereby incorporated by reference herein.

At action 330B, the rendering commands generated at action 320B are output to the rendering functional module 280. This may involve packetizing the generated rendering commands into a set of rendering commands 204 that is sent to the rendering functional module 280.

Those skilled in the art will appreciate that multiple instantiations of the graphics control process 300B described above may be executed, resulting in multiple sets of rendering commands 204.

VI. Generation of Graphics Output

The rendering functional module 280 interprets the sets of rendering commands 204 and produces multiple video data streams 205, one for each participating client device. Rendering may be achieved by the GPUs 240R, 250R, 240H, 250H under control of the CPUs 220R, 222R (in FIG. 2A) or 220H, 222H (in FIG. 2B). The rate at which frames of video data are produced for a participating client device may be referred to as the frame rate.

In an embodiment where there are N participants, there may be N sets of rendering commands 204 (one for each participant) and also N video data streams 205 (one for each participant). In that case, rendering functionality is not shared among the participants. However, the N video data streams 205 may also be created from M sets of rendering commands 204 (where M<N), such that fewer sets of rendering commands need to be processed by the rendering functional module 280. In that case, the rendering functional unit 280 may perform sharing or duplication in order to generate a larger number of video data streams 205 from a smaller number of sets of rendering commands 204. Such sharing or duplication may be prevalent when multiple participants (e.g., spectators) desire to view the same camera perspective. Thus, the rendering functional module 280 may perform functions such as duplicating a created video data stream for one or more spectators.

Next, the video data in each of the video data streams 205 are encoded by the video encoder 285, resulting in a sequence of encoded video data associated with each client device, referred to as a graphics output stream. In the example embodiments of FIGS. 2A to 2C, the sequence of encoded video data destined for client device 120 is referred to as graphics output stream 206, while the sequence of encoded video data destined for client device 120A is referred to as graphics output stream 206A.

The video encoder 285 can be a device (or set of computer-readable instructions) that enables or carries out or defines a video compression or decompression algorithm for digital video. Video compression transforms an original stream of digital image data (expressed in terms of pixel locations, color values, etc.) into an output stream of digital image data that conveys substantially the same information but using fewer bits. Any suitable compression algorithm may be used. In addition to dare compression, the encoding process used to encode a particular frame of video data may or may not involve cryptographic encryption.

The graphics output streams 206, 206A created in the above manner are sent over the Internet 130 to the respective client devices. By way of non-limiting example, the graphics output streams may be segmented and formatted into packets, each having a header and a payload. The header of a packet containing video data for a given participant may include a network address of the client device associated with the given participant, while the payload may include the video data, in whole or in part. In a non-limiting embodiment, the identity and/or version of the compression algorithm used to encode certain video data may be encoded in the content of one or more packets that convey that video data. Other methods of transmitting the encoded video data will occur to those of skill in the art.

While the present description focuses on the rendering of video data representative of individual 2-D images, the present invention does not exclude the possibility of rendering video data representative of multiple 2-D images per frame to create a 3-D effect.

VII. Game Screen Reproduction at Client Device

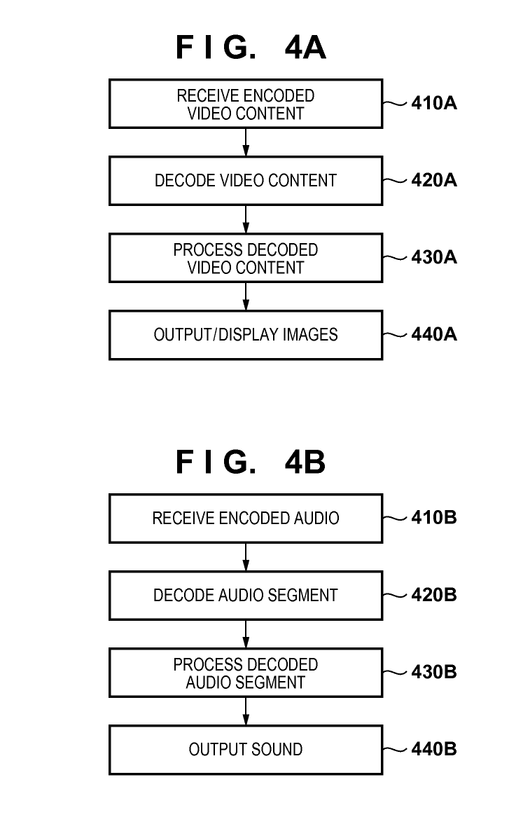

Reference is now made to FIG. 4A, which shows operation of the client device associated with a given participant, which may be client device 120 or client device 120A, by way of non-limiting example.

At action 410A, a graphics output stream (e.g., 206, 206A) is received over the Internet 130 from the rendering server 200R (FIG. 2A) or from the hybrid server 200H (FIG. 2B), depending on the embodiment. The received graphics output stream comprises compressed/encoded of video data which may be divided into frames.

At action 420A, the compressed/encoded frames of video data are decoded/decompressed in accordance with the decompression algorithm that is complementary to the encoding/compression algorithm used in the encoding/compression process. In a non-limiting embodiment, the identity or version of the encoding/compression algorithm used to encode/compress the video data may be known in advance. In other embodiments, the identity or version of the encoding/compression algorithm used to encode the video data may accompany the video data itself.

At action 430A, the (decoded/decompressed) frames of video data are processed. This can include placing the decoded/decompressed frames of video data in a buffer, performing error correction, reordering and/or combining the data in multiple successive frames, alpha blending, interpolating portions of missing data, and so on. The result can be video data representative of a final image to be presented to the user on a per-frame basis.

At action 440A, the final image is output via the output mechanism of the client device. For example, a composite video frame can be displayed on the display of the client device.

VIII. Audio Generation

A third process, referred to as the audio generation process, is now described with reference to FIG. 3C. The audio generation process executes continually for each participant requiring a distinct audio stream. In one embodiment, the audio generation process may execute independently of the graphics control process 300B. In another embodiment, execution of the audio generation process and the graphics control process may be coordinated.

At action 310C, the video game functional module 270 determines the sounds to be produced. Specifically, this action can include identifying those sounds associated with objects in the virtual world that dominate the acoustic landscape, due to their volume (loudness) and/or proximity to the participant within the virtual world.

At action 320C, the video game functional module 270 generates an audio segment. The duration of the audio segment may span the duration of a video frame, although in some embodiments, audio segments may be generated less frequently than video frames, while in other embodiments, audio segments may be generated more frequently than video frames.

At action 330C, the audio segment is encoded, e.g., by an audio encoder, resulting in an encoded audio segment. The audio encoder can be a device (or set of instructions) that enables or carries out or defines an audio compression or decompression algorithm. Audio compression transforms an original stream of digital audio (expressed as a sound wave changing in amplitude and phase over time) into an output stream of digital audio data that conveys substantially the same information but using fewer bits. Any suitable compression algorithm may be used. In addition to audio compression, the encoding process used to encode a particular audio segment may or may not apply cryptographic encryption.

It should be appreciated that in some embodiments, the audio segments may be generated by specialized hardware (e.g., a sound card) in either the compute server 200C (FIG. 2A) or the hybrid server 200H (FIG. 2B). In an alternative embodiment that may be applicable to the distributed arrangement of FIG. 2A, the audio segment may be parametrized into speech parameters (e.g., LPC parameters) by the video game functional module 270, and the speech parameters can be redistributed to the destination client device (e.g., client device 120 or client device 120A by the rendering server 200R.

The encoded audio created in the above manner is sent over the Internet 130. By way of non-limiting example, the encoded audio input may be broken down and formatted into packets, each having a header and a payload. The header may carry an address of a client device associated with the participant for whom the audio generation process is being executed, while the payload may include the encoded audio. In a non-limiting embodiment, the identity and/or version of the compression algorithm used to encode a given audio segment may be encoded in the content of one or more packets that convey the given segment. Other methods of transmitting the encoded audio will occur to those of skill in the art.

Reference is now made to FIG. 4B, which shows operation of the client device associated with a given participant, which may be client device 120 or client-device 120A, by way of non-limiting example.

At action 410E, an encoded audio segment is received from the compute server 200C, the rendering server 200R or the hybrid server 200H (depending on the embodiment). At action 420B, the encoded audio is decoded in accordance with the decompression algorithm that is complementary to the compression algorithm used in the encoding process. In a non-limiting embodiment, the identity or version of the compression algorithm used to encode the audio segment may be specified in the content of one or more packets that convey the audio segment.

At action 430B, the (decoded) audio segments are processed. This can include placing the decoded audio segments in a buffer, performing error correction, combining multiple successive waveforms, and so on. The result can be a final sound to be presented to the user on a per-frame basis.

At action 440B, the final generated sound is output via the output mechanism of the client device. For example, the sound is played through a sound card or loudspeaker of the client device.

IX. Specific Description of Non-Limiting Embodiments

A more detailed description of certain non-limiting embodiments of the present invention is now provided.

### EMBODIMENTS

### Menu Extension Processing

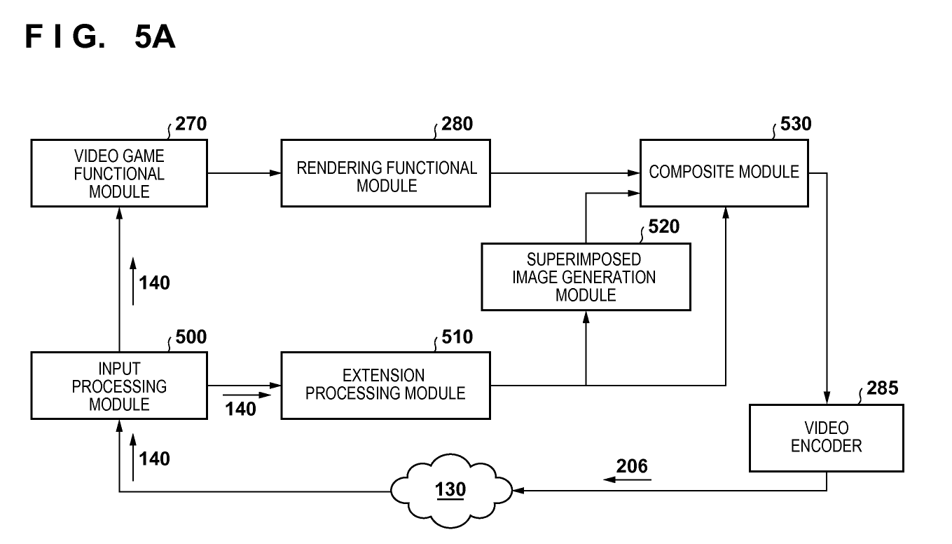

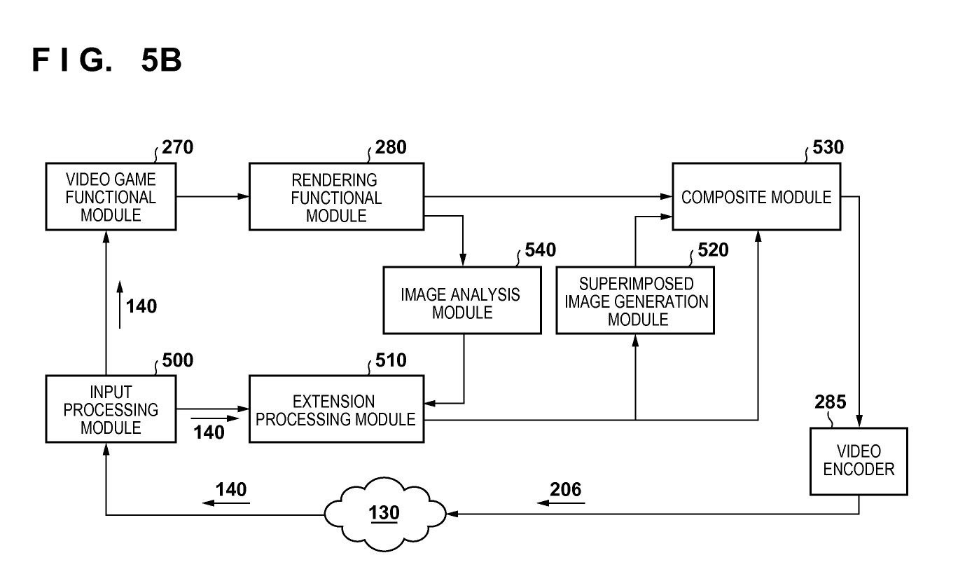

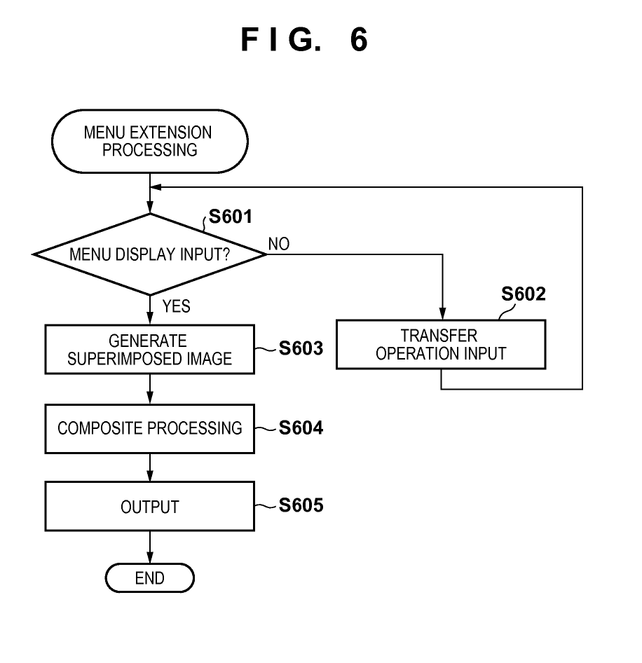

Details of menu extension processing on the server side (server system 100, compute server 200C and rendering server 200R or hybrid server 200H) according to an embodiment as one form of the present invention, which is executed on the server side of the system having the above arrangement, will be described with reference to the block diagram of FIG. 5A and the flowchart of FIG. 6.

Menu extension processing is processing of adding a menu item of a new function (extended function) to existing menu items displayed when, for example, predetermined operation input is done by the main process of a content provided by the server, thereby extending the function. In this embodiment, the provided content is a game content, as described above. The main process is a process of performing a series of processes for the game content by changing the game status in accordance with input of the client device input 140 received from the client device 120 and rendering and outputting a game screen corresponding to the status after the change. That is, the main process is a process executed by the video game functional module 270 and the rendering functional module 280 described above.

FIG. 5A is a block diagram showing a module arrangement for execution of menu extension processing on the server side according to the embodiment of the present invention in accordance with the flow of processing and data.

The client device input 140 received via the Internet 130 is first checked by an input monitoring module 500. In this embodiment, the input monitoring module 500 first checks whether the input done is input for menu display, and determines whether the situation requires to execute processing of displaying a menu item for an extended function. The input monitoring module 500, for example, always monitors the received client device input 140, and directly outputs the received client device input 140 to the video dame functional module 270 until input for menu display is done. In addition, after menu display, the input monitoring module 500 monitors whether input for selecting the added menu item is done during the time display concerning the menu is included in the screen.

Upon receiving an instruction to execute processing of displaying a menu item for an extended function from the input monitoring module 500, an extension processing module 510 executes various processes for adding the menu item for the extended function to the game screen generated by the main process. More specifically, the extension processing module 510 performs processing of causing a superimposed image generation module 520 to render the display item of the menu item or the like that is to be superimposed on the game screen. When input for selecting the menu item for the extended function (input for an instruction to execute processing corresponding to the item) is done, the extension processing module 510 executes the corresponding processing (extension processing).

The superimposed image generation module 520 renders the display item of the menu item for the extended function and other display items, and generates a superimposed image to be superimposed on the game screen generated by the main process. The superimposed image generation module 520 may additionally generate mask data to be used in composite processing for superimposition. The mask data may represents the transparency level of each pixel of the superimposed image when superimposing the superimposed image on the came screen. The data of the display item of the menu item and information such as a display position may be recorded in a recording device (not shown) in advance.

A composite module 530 performs composite processing of superimposing the superimposed image generated by the superimposed image generation module 520 on the game screen generated by processing in the main process, thereby generating a new game screen (composite screen). The composite module 530 outputs the generated composite screen to the video encoder 285. Even when no superimposed image needs to be generated, the composite module 530 receives input of the game screen generated by the main process. In this case, the game screen is directly output to the video encoder 285.

Details of menu extension processing implemented by such a module arrangement will be described with reference to the flowchart of FIG. 6. Processing corresponding to this flowchart can be implemented when the CPU 222 reads out a corresponding processing program stored in, for example, a recording device (not shown), loads the program to the RAM 230, and executes it independently of the main process.

In step S601, the input monitoring module 500 determines whether the client device input 140 received from the client device 120 is input for menu display (normal menu display). Upon determining that the client device input 140 is input for normal menu display, the input monitoring module 500 transmits, to the extension processing module 510, an instruction to execute processing of displaying a menu item for an extended function, transfers the operation input of the client device input 140 to the main process, and advances the process to step S603. Upon determining that the client device input 140 is not input for normal menu display, the input monitoring module 500 transfers the operation input of the client device input 140 directly to the main process in step S602, and returns the process to step S601.

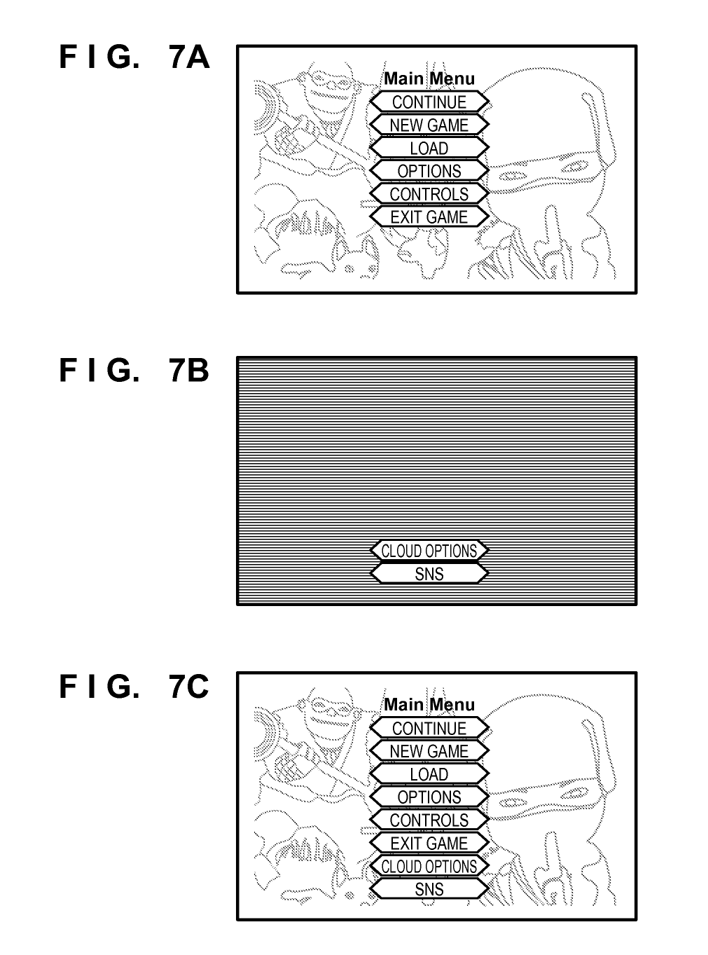

In step S603, the extension processing module 510 causes the superimposed image generation module 520 to render a superimposed image including the menu item for the extended function and used to add the selected item to the normal menu display arranged on the game screen by processing of the main process. When the normal menu display is done as in, for example, FIG. 7A, the superimposed image can be as in FIG. 7B. In this embodiment, as the image data of the menu item for the extended function, data that combines the design and menu items arranged on the game screen in normal menu display is prepared in advance and recorded in a recording device. Information of the arrangement position of the menu item for the extended function is also predetermined in consideration of the arrangement interval of the menu items in the normal menu display and recorded in the recording device. Hence, upon receiving a superimposed image generation instruction, the superimposed image generation module 520 acquires the image data of the menu item and information of its arrangement position, and generates a superimposed image. Note that in this embodiment, a description will be made assuming that the superimposed image generation module 520 generates a superimposed image upon receiving an instruction from the extension processing module 510. However, the practice of the present invention is not limited to this. It should be appreciated that since the menu item for the extended function to be arranged in the superimposed image does not dynamically change, for example, the superimposed image itself may be recorded in the recording device in advance.

In step S604, the extension processing module 510 causes the composite module 530 to composite the superimposed image generated by the superimposed image generation module 520 with the game screen generated by the rendering functional module 280 in correspondence with operation input received in the same frame and generate a composite image. The composite module 530 superimposes, for example, pixels having colors other than those defined not to be superimposed out of the superimposed image at the same pixel positions of the game screen, thereby generating the composite image. When a game screen as shown in FIG. 7A is generated, and a superimposed image as shown in FIG. 7E is generated, hatched pixels in FIG. 7B are handled as pixels to be made transparent at the time of superimposition and are therefore not superimposed. Conversely, the remaining pixels are processed as to be superimposed, and a new game screen (composite image) including menu display with the additional menu item for the extended function as shown in FIG. 7C is generated.

In step S605, the composite module 530 outputs the generated composite image to the video encoder 285 as the game screen, and terminates the menu extension processing.

This makes it possible to generate a new game screen in which a new menu item is arranged in normal menu display displayed on the game screen by processing of the main process without the necessity of causing the main process to perform special processing.

### Display Update Processing

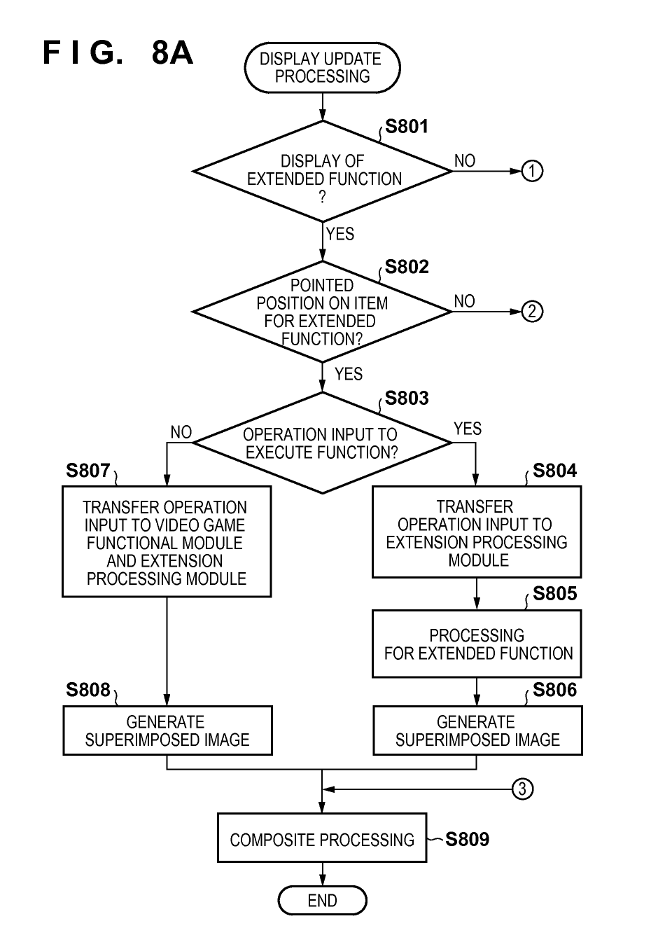

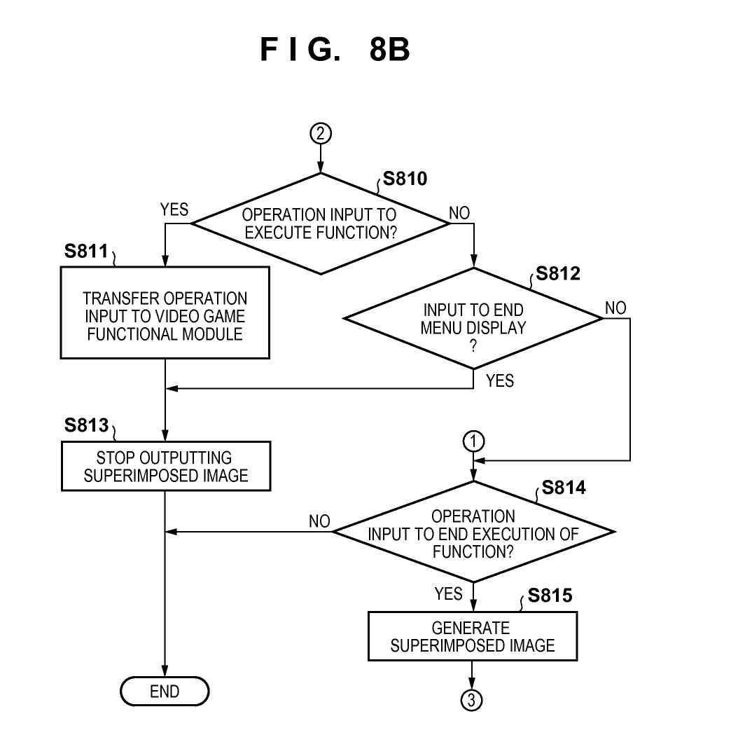

A method of changing the superimposed image and updating display in accordance with predetermined operation input to the thus generated menu display with an extended function will be described next with reference to the flowcharts of FIGS. 8A and 8B. This display update processing is executed for each processing frame of the game program of the main process during rendering processing of menu display. At this time, the client device input 140 is received on a per-frame basis.

In this embodiment, a description will be made assuming that the operation input to menu display in the client device 120 is done using a pointing device such as a mouse for the sake of descriptive simplicity. Each menu item of menu display behaves to highlight itself when an operation (mouse-over) of making an indicator position indicated by the pointing device enter a region corresponding to the item is performed. When the pointed position exists within a region corresponding to a menu item, and operation input (mouse click) corresponding to determination is done, the menu item behaves to execute a function corresponding to it and make a transition to new display such as a setting screen or further superimpose a setting window. When the pointed position exists within a region corresponding to a display item (item different from the menu items) configured to end the menu display, and operation input corresponding to determination is done, the display is turned off.

In step S801, the input monitoring module 500 determines whether a menu item for an extended function or a display item displayed by execution of an extended function is included in a screen to be provided to the client device 120. That is, the input monitoring module 500 determines whether a superimposed image is being superimposed on the game screen currently generated by the main process. Upon determining that a superimposed image is being superimposed on the game screen, the input monitoring module 500 advances the process to step S802. Upon determining that no superimposed image is being superimposed, the input monitoring module 500 advances the process to step S814.

In step S802, the input monitoring module 500 determines whether the pointed position indicated by the received client device input 140 is included in a region where the menu item for the extended function is arranged. Upon determining that the pointed position is included in the region where the menu item for the extended function is arranged, the input monitoring module 500 advances the process to step S803. Upon determining that the pointed position is not included, the input monitoring module 500 advances the process to step S810.

In step S803, the input, monitoring module 500 determines whether the client device input 140 includes information of operation input to execute the function of the menu item. That is, the input monitoring module 500 determines whether the pointed position exists in the region where the menu item for the extended function is arranged, and operation input (e.g., mouse click) to select the menu item has been performed. Upon determining that the information of operation input to execute the function is included, the input monitoring module 500 advances the process to step S604. Upon determining that the information is not included, the input, monitoring module 500 advances the process to step S807.

In step S804, the input monitoring module 500 transfers the received client device input 140 not to the video game functional module 270 but to the extension processing module 510 and advances the process to step S805. Operation input to execute the function corresponding to the menu item for the extended function does not correspond to operation input to perform any processing in the main process. Alternatively, the operation input may be determined as one to perform processing different from the extended function, and transition to an undesirable situation may occur so that, for example, the screen may transit to another screen, or a game that has paused may restart. In this embodiment, to prevent the main process from performing processing of the operation input, when operation input to execute the extended function is performed, the input monitoring module 500 transfers the operation input not to the main process but only to the extension processing module 510. That is, a situation is apparently created in which a sub-process other than the main process temporarily seize authority to process operation input to execute the extended function.

In step S805, the extension processing module 510 executes processing of the extended function corresponding to the menu item arranged at the pointed position. The processing of the extended function can include above-described screen transition or a change in the display form of the menu item or another item caused by selection of the menu item. At this time, the extension processing module 510 may control the video game functional module 270 to stop execution of processing in the main process.

The processing of the extended function may include processing for settings for an additional content element that is not implemented in the game content of the main process or settings of key assignment to play the game content in the client device 120 of various kinds of hardware. It may be processing for allowing the player to change settings such as communication settings and distribution image quality settings typical to the cloud gaming system during an experience of a game. In addition, since the service is provided via the Internet, cooperation functions with other services using the Internet such as settings for upload to an arbitrary SNS (Social Networking Site) or video uploading site, access and order functions for associated goods sales sites, and an order function to pizza delivery for a player during an experience of a game may be provided as extended functions.

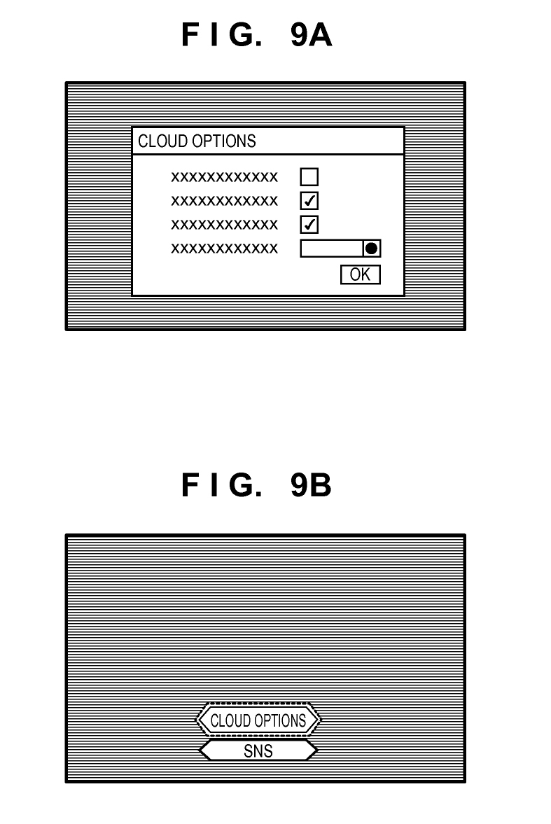

In step S806, the superimposed image generation module 520 generates a superimposed image for the selected extended function under the control of the extension processing module 510. The superimposed image for the selected extended function can be a setting window or a screen for a specific application, as shown in FIG. 9A. In this embodiment, a description will be made assuming that the image for the extended function is an image to be superimposed on the game screen rendered by the rendering functional module 280 in the main process. However, the image is not limited to this in the practice of the present invention. The image for the extended function may be, for example, an image constructing the entire screen, and may be output as a screen to be provided to the client device 120 without being superimposed on the game screen, as will be described later.

On the other hand, upon determining in step S803 that information of operation input to execute the function is not included, the input monitoring module 500 transfers the client device input 140 to the video game functional module 270 and the extension processing module 510 in step S807, and advances the process to step S808. In this embodiment, a description will be made assuming that simple mouse-over on the menu item of the extended function leads to processing different from the extended function in the main process, and processing in the main process is not executed. However, if arbitrary processing in the main process is to be executed by an operation of changing the pointed position such as mouse-over, the input monitoring module 500 may transfer the client device input 140 only to the extension processing module 510 in this step.

In step S808, the superimposed image generation module 520 generates a superimposed image as shown in FIG. 9B, which highlights the menu item for the extended function corresponding to the pointed position indicated by the client device input 140, under the control of the extension processing module 510.

In step S809, the composite module 530 composites the game screen generated by the rendering functional module 200 with the superimposed image generated by the superimposed image generation module 520 to generate a composite image under the control of the extension processing module 510.

On the other hand, upon determining in step S802 that the pointed position indicated by the client device input 140 is not included in the region where the menu item for the extended function is arranged, the input monitoring module 500 determines in step S810 whether the client device input 140 includes information of operation input to execute the function of a menu item (normal menu item) arranged in normal menu display. That is, the input monitoring module 500 determines whether the pointed position exists in the region where a normal menu item is arranged, and operation input to select the menu item has been performed. The information of the position of each normal menu item may be recorded in a recording device in advance, or obtained by, for example, analyzing the image of the game screen before and after the display of the normal menu item and specifying the position where a display item of a predetermined shape is arranged. Upon determining that the information of operation input to execute the function of the normal menu item is included, the input monitoring module 500 advances the process to step S811. Upon determining that the information is not included, the input monitoring module 500 advances the process to step S812.

In step S811, the input monitoring module 500 transfers the received client device input 140 only to the video game functional module 270 and advances the process to step S813. In addition, the input monitoring module 500 notifies the extension processing module 510 that operation input to execute the function of the normal menu item has been done.

In step S812, the input monitoring module 500 determines whether the client device input 140 includes information of operation input to end normal menu display. Upon determining that the information of operation input to end normal menu display is included, the input monitoring module 500 advances the process to step S813. Upon determining that the information is not included, the input monitoring module 500 advances the process to step S814.

in step S813, the extension processing module 510 causes the superimposed image generation module 520 to stop generating and outputting a superimposed image. The extension processing module 510 also causes the composite module 530 to stop executing composite processing. That is, in this step, the extension processing module 510 performs processing of controlling not to superimpose a superimposed image to avoid an obstacle to the item displayed by executing the function of the normal menu item.

In step S814, the input monitoring module 500 determines whether the client device input 140 includes operation input to end execution of the function of the normal menu item. That is, the input monitoring module 500 determines whether to superimpose the superimposed image (the menu item for the extended function), whose superimposition has been stopped by execution of the function of the normal menu item, again in accordance with the end of display of the item displayed by executing the function. Upon determining that operation end execution of the function of the normal menu item is included, the input monitoring module 500 advances the process to step S815. Upon determining that the operation input is not included, the input monitoring module 500 terminates the display update processing.

In step S815, the extension processing module 510 causes the superimposed image generation module 520 to render a superimposed image in which the menu item for the extended function is arranged, and advances the process to step S809.

This makes it possible to execute display transition of the display item for the extended function and execution of the extended function by a process different from the main process on the server side of the system according to this embodiment. In addition, since the superimposed image is updated by this execution, a screen for a medium output 150 finally provided to the client device 120 can present display for function extension of a provided content to the player without a sense of incongruity.

### First Modification

In the above-described embodiment, a method has been explained in which a menu item for an extended function is superimposed, and upon receiving operation input to the item, a sub-process temporarily seizes authority to process the operation input from the main process and executes processing of the extended function. However, the method of providing a user experience with extended functions when providing an existing content without altering the program of the content is not limited to this. In this modification, a method will be described in which a change in the main process caused by operation input is detected, and extended display is superimposed, thereby providing a user experience with extended functions, instead of allowing a sub-process to seize authority to process operation input.

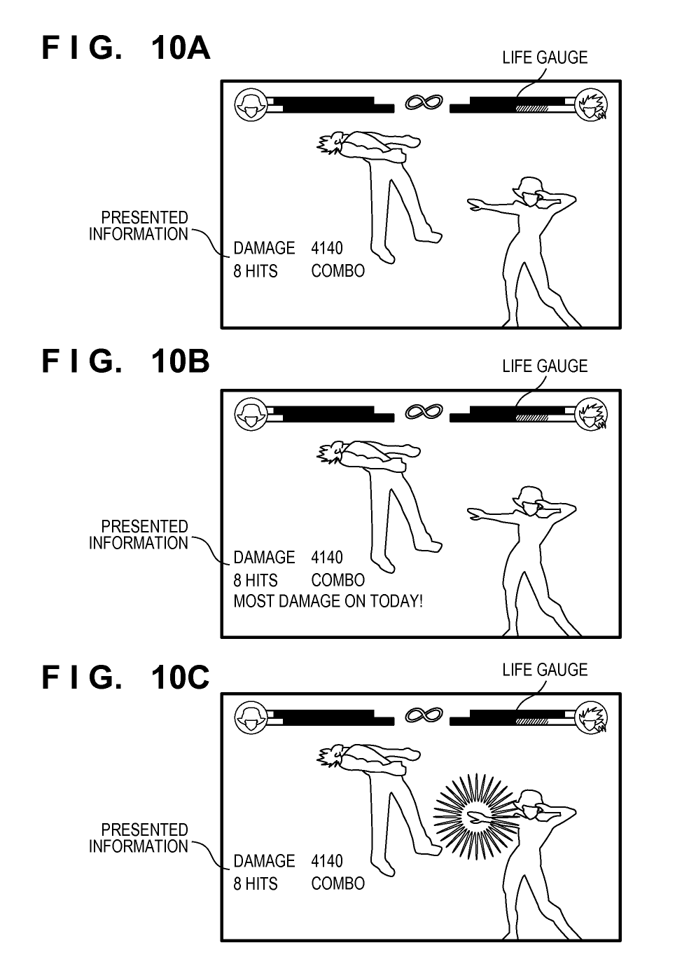

Some game contents performs text display to present information of a result of processing based on done operation input, as shown in FIG. 10A. Such text display is configured to display only predetermined information set at the time of development of a content. When different information other than the predetermined information is presented, the user experience can be extended.

A game screen shown in FIG. 10A is that of a so-called fighting game. This screen includes the life gauge of each character. For example, assume a case where the total damage amount (life decrement) within a so-called combo period where a character is continuously damaged is measured, and users who use the corresponding content in the cloud gaming system are ranked on a daily basis (for example, leaderboard). Pieces of information of, for example, the combo period and a parameter representing life in the life gauge are managed by processing of the video game functional module 270 and stored in a predetermined storage area such as the RAM 230. In this case, upon determining that the client device input 140 includes operation input to attack, the input monitoring module 500 notifies the extension processing module 510 of it, and the extension processing module 510 measures the decrement of the life parameter by the attack during the combo period. At the end of the combo period, the extension processing module 510 compares the life decrement value with the maximum life decrement value of the day managed for system users. When the life decrement value is larger than the maximum life decrement value, the extension processing module 510 causes the superimposed image generation module 520 to generate a superimposed image in which text display representing that the user has marked the maximum life decrement value of the day is arranged at a predetermined position. At this time, the text display arranged in the superimposed image preferably use the font used in the game. The composite module 530 composites the superimposed image with the game screen generated by the main process to generate and output a composite image as shown in FIG. 10B under the control of the extension processing module 510. Note that the number of rows and the arrangement position of text display can change in accordance with the progress of the game content and may therefore be decided by monitoring parameters or analyzing the image of the game screen.

As described above, when the extension processing module 510 monitors intermediate data output by the main process or parameters and the like managed by the main process, extended information obtained by variously evaluating these pieces of information can be included in the screen of the content and provided. Note that in this modification, a method of presenting information using a change in the life parameter as an evaluation target has been described as an example. However, it should easily be appreciated that the evaluation target, evaluation method and information to be presented are not limited to these.

### Second Modification

In the above-described first modification, a method of monitoring parameters managed by the main process and providing a game screen in which corresponding text display is arranged at a predetermined position has been explained. However, the method of extending a user experience by display is not limited to this in the practice of the present invention. In this modification, the system further includes an image analysis module 540 configured to analyze a game screen generated by the rendering functional module 280 in the main process, as shown in FIG. 5B. A method of causing the image analysis module 540 to analyze at game screen to detect a change in parameters will be described. That is, instead of monitoring internally-managed parameter values, the method detects the state in the game content or the execution state of processing for the game content by analyzing the game screen.

For example, a game screen as shown in FIG. 10A includes a life gauge or text display of a result of operation input, as described above. The image analysis module 540 can detect the state in the game by detecting the change amount of the life gauge or performing text recognition based on the difference or correlation of the game screen between continuous frames. More specifically, when these pieces of information detected by the image analysis module 540 are transmitted to the extension processing module 510, the extension processing module 510 can perform, for example, evaluation of parameter changes as described above. That is, the extension processing module 510 can grasp the combo period or a given damage amount from the text recognition result. The extension processing module 510 can also grasp occurrence of the effect of giving an abrupt decrease in life from a change in the life gauge.

Information presentation is not limited to text display as described in the first modification, and may be done by, for example, superimposing predetermined effect display on a portion where clash of characters takes place, as shown in FIG. 10C. This can be done by, for example, when the extension processing module 510 has received a detection result representing an abrupt decrease in life from the image analysis module 540, causing the superimposed image generation module 520 to generate a superimposed image in which effect display is arranged at a portion where a motion vector having a scalar of a predetermined value or more is detected between preceding and subsequent frames.

In this modification, a description has been made assuming that the extension processing module 510 decides whether to do information presentation by image analysis of the game screen. However, the practice of the present invention is not limited to this. It may be decided whether to do information presentation based on, for example, information such as the number of command inputs or a variation in an analog value from the history of the client device input 140 received by the input monitoring module 500. Alternatively, it may be decided whether to do information presentation based on, for example, whether an audio signal output in accordance with the game screen includes a sound of an amplitude of a predetermined value or more. Otherwise, it may be decided whether to do information presentation by combining these pieces of information.

### Third Modification

In the above-described first and second modifications, en explanation has been made assuming that a superimposed image aiming at information presentation or effect display is generated. However, the practice of the present invention is not limited to this.

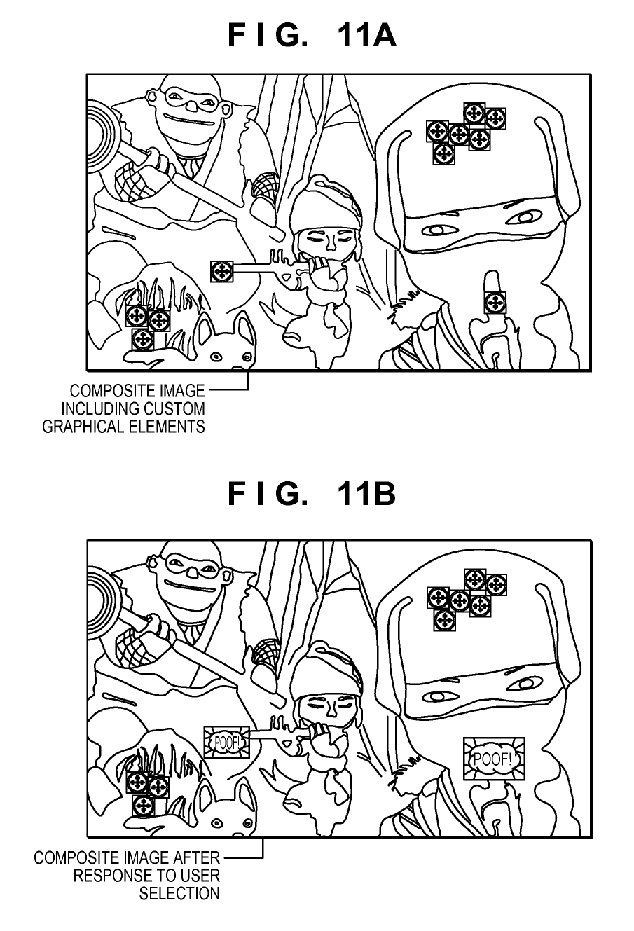

For example, as shown in FIG. 11A, a sub-game may be provided, which arranges display items such as an icon in a region of interest detected in a game screen by a predetermined method, and the user collects the items by selecting them during transition of the game screen. In this case, when the client device input 140 includes operation input to select a display item, the input monitoring module 500 transfers the operation input not to the video game functional module 270 but to the extension processing module 510, and the extension processing module 510 performs processing such as score calculation for the item collection. To present that an item is collected, the extension processing module 510 may cause the superimposed image generation module 520 to generate a superimposed image as shown in FIG. 11B that changes the display item to display representing that the item is collected and superimpose the image on the provided game screen. In addition, a predetermined rendering effect may be provided when generating the superimposed image so as to integrate the display items to be arranged with the atmosphere (illumination, shading, reflection and camera angle) of rendered objects on the game which exist at the arrangement positions in the game screen.

Note that the region of interest may be specified by causing the image analysis module 540 shown in FIG. 5B to detect, for example, a region of the game screen without a change between continuous frames or a region where the edge components exhibit an intensity equal to or more than a threshold, and the contrast ratio to the peripheral region is high. The region of interest may be specified by causing the image analysis module 540 to detect a predetermined image pattern included in the game screen. Various other methods can appropriately be used to detect the region of interest.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. Also, the information processing apparatus and the controlling method according to the present invention are realizable by a program executing the methods on one or more computers. The program is providable/distributable by being stored on a computer-readable storage medium or through an electronic communication line.

This application claims the benefit of U.S. Provisional Patent Application No. 61/820,909 filed May 8, 2013, which is hereby incorporated by reference herein in its entirety.

1-15 (canceled)

16. An information processing apparatus comprising:
a receiver which is able to receive operation input for a content;
a first generator which is able to generate a first image corresponding to the content by executing a first program for the content in accordance with the operation input received by said receiver;
a second generator which is able to generate a second image to be added to the first image by executing a second program different from the first program;
an outputter which is able to output a composite image obtained by compositing the first image and the second image; and
a controller which is able to, in a case where said receiver receives the operation input to a region according to the second image in the composite image, control not to cause said first generator to execute the first program in accordance with the operation input.

17. The apparatus according to claim 16, wherein in a case where said receiver receives the operation input to the region according to the second image, said second generator updates the second image.

18. The apparatus according to claim 16, wherein the second image includes a display item configured to instruct to execute a function that is not implemented by the first program and
in a case where said receiver receives the operation input to the region according to the second image, said second generator executes, out of the second program, a program of a function corresponding to the display item arranged in the region

19. The apparatus according to claim 18, wherein the function that is not implemented by the first program comprises one of a function of changing a setting typical to the information processing apparatus or a cooperation function with a service using the Internet.

20. The apparatus according to claim 16, wherein said controller causes said first generator not to execute the first program in accordance with the operation input to the region according to the second image by not transferring the operation input.

21. An information processing apparatus comprising:
a receiver which is able to receive operation input for a content;
a first generator which is able to generate a first image corresponding to the content by executing a first program for the content in accordance with the operation input received by said receiver;
a monitor which is able to monitor a predetermined parameter that changes during execution of the first program;
a second generator which is able to a second image to be added to the first image by executing a second program different from the first program in a case where the predetermined parameter meets a predetermined condition; and
an outputter which is able to output a composite image obtained by compositing the first image and the second image.

22. An information processing apparatus comprising:
a receiver which is able to receive operation input for a content;
a first generator which is able to generate a first image corresponding to the content by executing a first program for the content in accordance with the operation input received by said receiver;
an analyzer which is able to analyze the first image and detecting whether an execution state of the content meets a predetermined condition;
a second generator which is able to generate a second image to be added to the first image by executing a second program different from the first program in a case where the execution state meets the predetermined condition; and
an outputter which is able to output a composite image obtained by compositing the first image and the second image.

23. The apparatus according to claim 21, wherein said analyzer further decides a position where a display item is to be arranged in the second image by analyzing the first image, and
said second generator generates the second image in which the display item is arranged at the position decided by said analyzer.

24. An information processing apparatus comprising:
a receiver which is able to receive operation input for a content;
a first generator which is able to generate a first image corresponding to the content by executing a first program for the content in accordance with the operation input received by said receiver;
an analyzer which is able to analyze the first image and deciding a position where a display item is to be arranged;
a second generator which is able to generate a second image to be added to the first image, in which the display item is arranged at the position decided by said analyzer, by executing a second program different from the first program; and
an outputter which is able to output a composite image obtained by compositing the first image and the second image.

25. The apparatus according to claim 16, wherein said outputter generates the composite image by superimposing the second image on the first image.

26. A control method of an information processing apparatus, comprising:
receiving operation input for a content;
generating a first image corresponding to the content by executing a first program for the content in accordance with the received operation input;
generating a second image to be added to the first image by executing a second program different from the first program;
outputting a composite image obtained by compositing the first image and the second image; and
controlling, in a case where the operation input to a region according to the second image in the composite image is received, not to execute the first program in accordance with the received operation input.

27. A control method of an information processing apparatus, comprising:
receiving operation input for a content;
generating a first image corresponding to the content by executing a first program for the content in accordance with the received operation input;
monitoring a predetermined parameter that changes during execution of the first program;
generating a second image to be added to the first image by executing a second program different from the first program in a case where the predetermined parameter meets a predetermined condition; and
outputting a composite image obtained by compositing the first image and the second image.

28. A control method of an information processing apparatus, comprising:
receiving operation input for a content;
generating a first image corresponding to the content by executing a first program for the content in accordance with the received operation input;
analyzing the first image and detecting whether an execution state of the content meets a predetermined condition;
generating a second image to be added to the first image by executing a second program different from the first program in a case where the execution state meets the predetermined condition; and
outputting a composite image obtained by compositing the first image and the second image.

29. A control method of an information processing apparatus, comprising:
receiving operation input for a content;
generating a first image corresponding to the content by executing a first program for the content in accordance with the received operation input;
analyzing the first image and deciding a position where a display item is to be arranged;
generating a second image to be added to the first image, in which the display item is arranged at the decided position, by executing a second program different from the first program; and
outputting a composite image obtained by compositing the first image and the second image.

30. A non-transitory computer-readable storage medium storing a program that causes at least one computer to function as each means of the information processing apparatus defined in claim 16.
